(19) United States
(12) Patent Application Publication
(10) Pub. No.: US 2024/0104608 A1
(43) Pub. Date: Mar. 28, 2024

(54) TECHNIQUES FOR SYNDICATING CUSTOMIZABLE CONTENT TO RECIPIENT ENTITIES

(71) Applicant: Apple Inc., Cupertino, CA (US)

(72) Inventor: John FREEBORN, San Jose, CA (US)

(21) Appl. No.: 18/161,011

(22) Filed: Jan. 27, 2023

Related U.S. Application Data
(60) Provisional application No. 63/376,867, filed on Sep. 23, 2022.

(51) Int. Cl. G06Q 30/0241; G06Q 30/0242; G06Q 30/0251

(52) U.S. Cl. CPC G06Q 30/0276; G06Q 30/0244; G06Q 30/0257

(57) ABSTRACT

This Application sets forth techniques for syndicating customizable content (e.g., marketing materials) to syndication recipients (e.g., online store providers). In particular, the techniques enable each syndication recipient to individually customize various aspects of the customizable content such that their customized content can be incorporated into respective content provided (to end users) by the syndication recipients.

### CROSS-REFERENCE TO RELATED APPLICATIONS

The present application claims the benefit of U.S. Provisional Application No. 63/376,867, entitled “TECHNIQUES FOR SYNDICATING CUSTOMIZABLE CONTENT TO RECIPIENT ENTITIES,” filed Sep. 23, 2022, the content of which is incorporated by reference herein in its entirety for all purposes.

### FIELD

The described embodiments set forth techniques for syndicating customizable content to syndication recipients. In particular, the techniques enable each syndication recipient to individually customize various aspects of the customizable content such that their customized content can be incorporated into respective content provided (to end users) by the syndication recipients.

### BACKGROUND

In present times, virtually all retailers/service providers offer some form of an online store through which customers can purchase goods/services. In some cases, originators of the goods/services (or contracted marketing entities) provide static (i.e., unchangeable) marketing materials to the online stores (referred to herein as syndication), which provides a variety of benefits. In particular, the originators can remain confident that their goods/services are being marketed in a uniform and consistent manner such that consumers are properly informed and not confused by conflicting information. Moreover, the online stores are not tasked with creating their own marketing materials for the goods/services of the originators, which otherwise would be burdensome and prone to result in the aforementioned deficiencies.

Despite the advantages of the above-described syndication techniques, several drawbacks continue to exist that have yet to be addressed. In one example, it can be desirable for the originators to vary different aspects of the marketing materials to account for distinctions in the goods/services relative to the locales in which they are sold. In another example, it can be desirable for the originators to account for the various languages used in the different locales in which the goods/services are sold. In yet another example, it can be desirable for the originators to account for available supplies of the goods/services relative to the locales in which they are sold. As a result, originators are commonly faced with the cumbersome task of generating voluminous collections of varying marketing materials for the different goods and services. Additionally, the difficulty of this task is exacerbated by the overall complexity involved in determining how, when, and where the varying marketing materials should be syndicated to the online stores. Moreover, it is noted that even if these difficult tasks are surmounted, a deficiency still exists in that the online stores are unable to exercise any customization over the static marketing materials despite the fact that a particular level of customization may be acceptable to the originator.

Accordingly, there exists a need for a technique for originators to syndicate customizable marketing materials to online stores in a manner that strikes a balance between the originators' desired level of uniformity and the online stores' desired level of customization.

### SUMMARY

This Application sets forth techniques for syndicating customizable content to syndication recipients. In particular, the techniques enable each syndication recipient to individually customize various aspects of the customizable content such that their customized content can be incorporated into respective content provided (to end users) by the syndication recipients.

One embodiment sets forth a method for syndicating customizable content. According to some embodiments, the method can be implemented by a server computing device associated with a syndication provider, and include the steps of (1) receiving a customizable content package from a content provider, wherein the customizable content package includes objects that enable a visual rendering of the customizable content package to be generated, (2) for each syndication recipient of a plurality of syndication recipients: (i) providing the customizable content package to the syndication recipient, (ii) receiving, from the syndication recipient, a content customization package that defines at least one modification to the customizable content package directed to adjusting the visual rendering, and (iii) generating a respective customized content package for the syndication recipient based on the customizable content package and the content customization package, (3) receiving, from a client computing device, a request to provide the respective customized content package for a particular syndication recipient of the plurality of syndication recipients, and (4) providing the respective customized content package to the client computing device.

Another embodiment sets forth a method for managing syndicated customizable content. According to some embodiments, the method can be implemented by a server computing device associated with a syndication recipient, and include the steps of (1) receiving, from a syndication provider, a customizable content package, wherein the customizable content package includes objects that enable a visual rendering of the customizable content package to be generated, (2) identifying at least one modification to the customizable content package that is directed to adjusting the visual rendering, (3) generating a content customization package based on the at least one modification, (4) providing the content customization package to the syndication provider to cause the syndication provider to generate a customized content package based on the customizable content package and the content customization package, (5) receiving a request to provide particular content to a client computing device, wherein the particular content references the customized content package, and (6) providing the particular content to the client computing device to cause the client computing device to access both the particular content and the customized content package.

Other embodiments include a non-transitory computer readable medium configured to store instructions that, when executed by a processor included in a computing device, cause the computing device to implement the methods and techniques described in this disclosure. Yet other embodiments include hardware computing devices that include processors that can be configured to cause the hardware computing devices to implement the methods and techniques described in this disclosure.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of a system for implementing the various techniques described herein, according to some embodiments.

FIGS. 2A-2E set forth conceptual diagrams of an example flow of how a customizable content package can be distributed to a syndication provider and customized by a syndication recipient, according to some embodiments.

FIG. 3 illustrates a method implemented by a syndication provider for syndicating customizable content, according to some embodiments.

FIG. 4 illustrates a method implemented by a syndication recipient for managing syndicated customizable content, according to some embodiments.

FIG. 5 illustrates a detailed view of a representative computing device that can be used to implement various methods described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

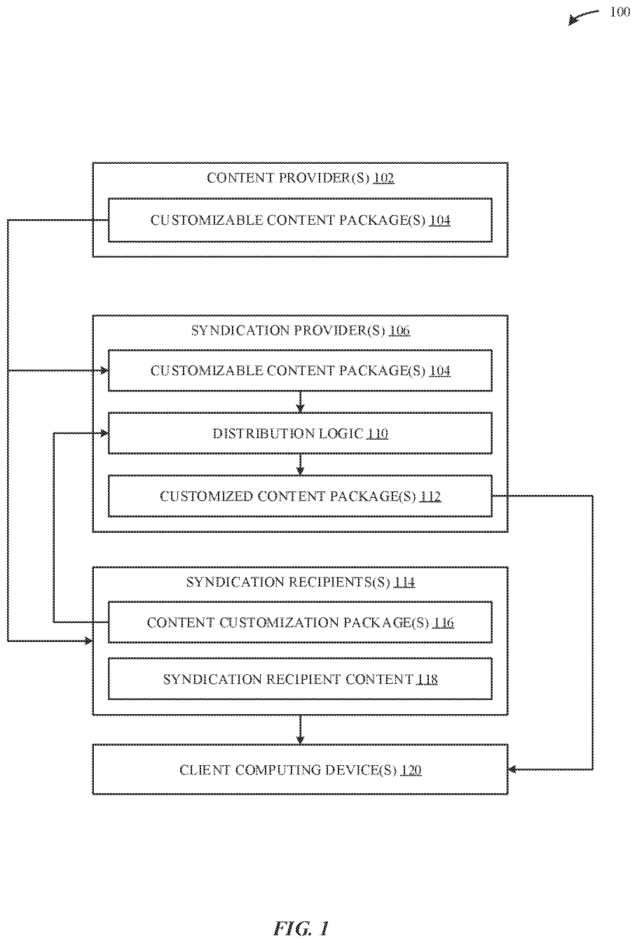

FIG. 1 illustrates a block diagram of different components of a system 100 for implementing the various techniques described herein, according to some embodiments. As shown in FIG. 1, the system 100 includes one or more content providers 102, one or more syndication providers 106, one or one more syndication recipients 114, and one or more client computing devices 120. According to some embodiments, a content provider 102 can represent any entity that provides customizable content packages 104. For example, a content provider can constitute a manufacturer of goods, a provider of services, and so on, where the content provider 102 typically generates marketing materials for such provisions. In some cases, the content provider 102 can (in and of itself) generate customizable content packages 104 and/or work in concert with other entities to generate customizable content packages 104. In any case, a customizable content package 104 can represent a collection of objects that enable a visual rendering of the content to be generated on computing devices. For example, a customizable content package 104 can represent image data, illustration data, sound data, video data, web page data, simulation data, and so on. It is noted that the foregoing examples are not meant to be limiting, and that the customizable content packages 104 can represent any conceivable package of information.

According to some embodiments, a syndication provider 106 can represent any entity that functions to receive customizable content packages 104 from the content providers 102 and to syndicate (i.e., distribute) the customizable content packages 104 to syndication recipients 114. In this regard, a given syndication provider 106 can represent, for example, an entity that specializes in the management and distribution of content, such as the marketing materials discussed above. In the same vein, a given syndication recipient 114 can represent, for example, an entity that has an interest in utilizing such marketing materials, such as an online store that sells the goods/services that are the subject of the marketing materials.

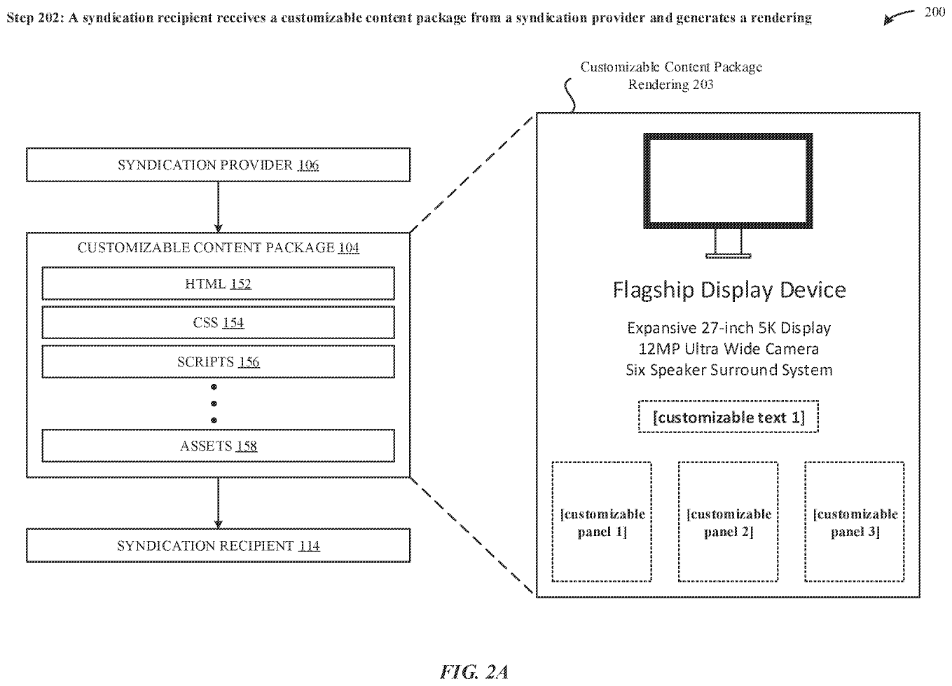

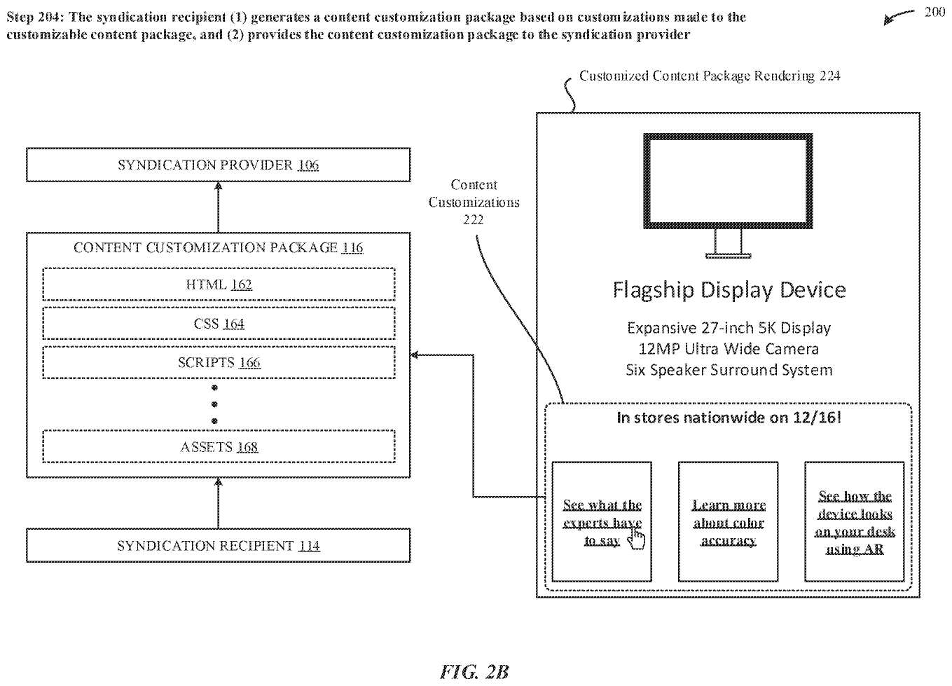

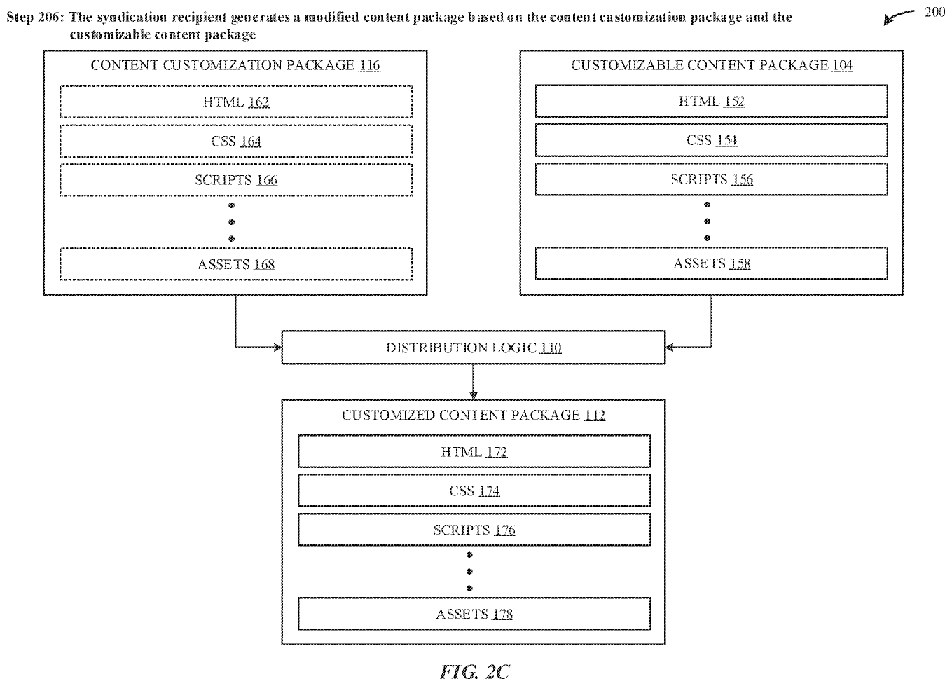

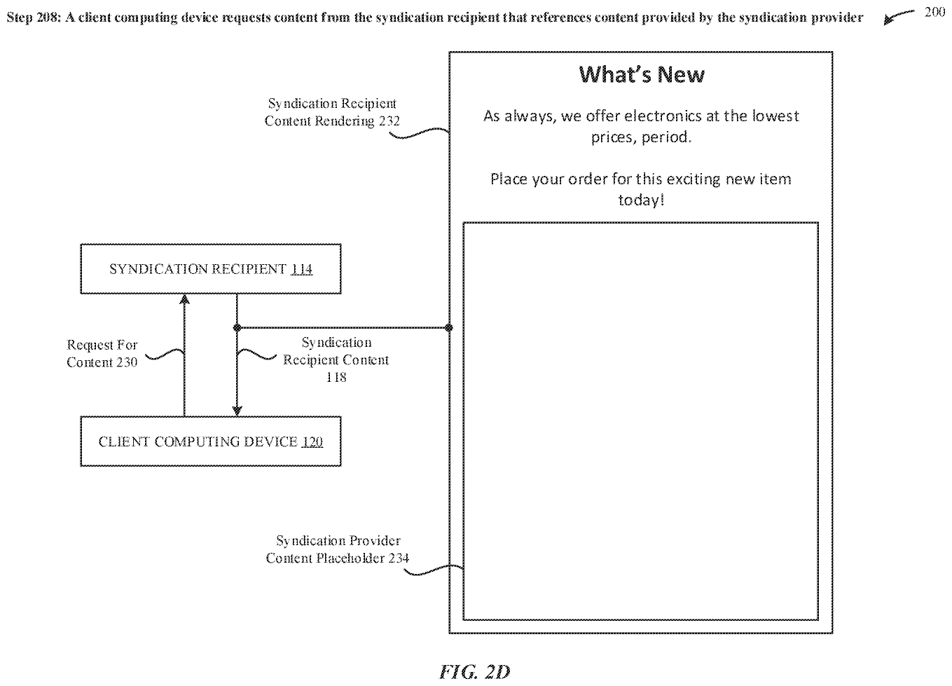

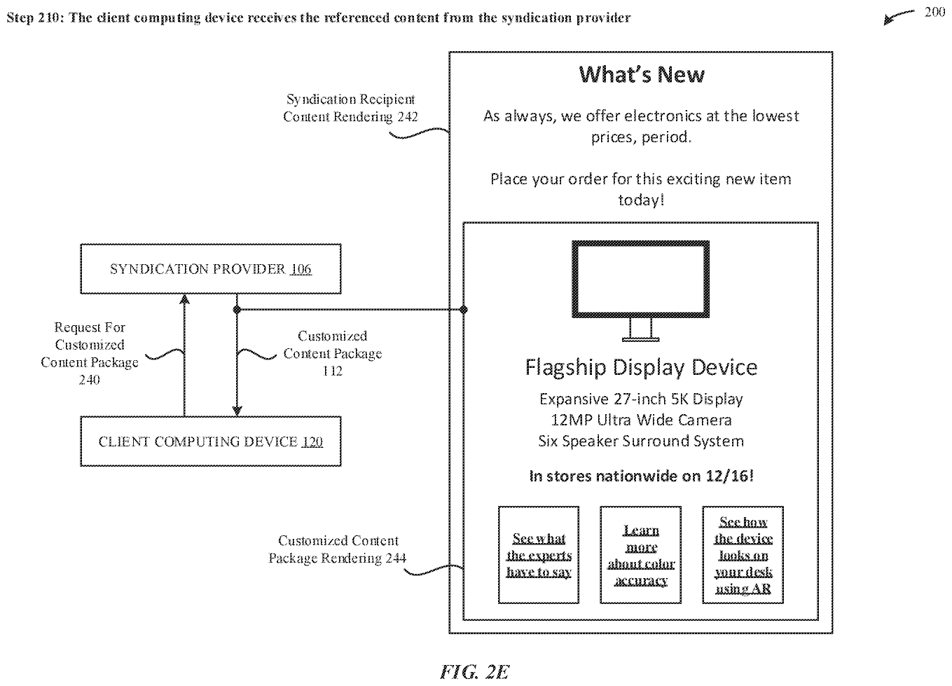

As shown in FIG. 1, a syndication provider 106 can receive a customizable content package 104 from a content provider 102, where the customizable content package 104 (or some other information provided by the content provider 102) identifies at least one syndication recipient 114 to which the customizable content package 104 should be provided. In turn, the syndication provider 106 can distribute the customizable content package 104 to the at least one syndication recipient 114 to enable the syndication recipient 114 to access the customizable content package 104 and identify customizations, if any, that the syndication recipient 114 desires to make to customizable areas of the customizable content package 104. In turn, syndication recipient 114 can document the desired changes using a content customization package 116 and provide the content customization package 116 back to the syndication provider 106. A more detailed description of the manner in which content customization packages 116 can be generated by syndication recipients 114 is provided below in conjunction with FIGS. 2A-2E.

When the syndication provider 106 receives the content customization package 116 from the syndication recipient 114, the syndication provider 106 can implement distribution logic 110 that is configured to generate a customized content package 112 based on the customizable content package 104 and the content customization package 116. For example, the distribution logic 110 can be configured to generate a delta that represents the distinctions between the customizable content package 104 and the content customization package 116. In this manner, the syndication provider 106 can reduce the overall amount of memory required to store the customized content package 112, given the modifications provided by the syndication recipient 114 can be generated using the customized content package 112 and the customizable content package 104. It is noted, however, that while this approach can lead to data storage savings, it can also lead to higher processing requirements. In that regard, the customized content package 112 can instead be configured to store the net result of the changes made to the customizable content package 104 based on the customized content package 112, which would result in storage costs but processing savings. It is noted that the foregoing approaches are not meant to be limiting, and that the customizable content packages 104/customized content packages 112 can be managed in accordance with operating parameters of the syndication provider 106.

Additionally, it is noted that the customized content package 112 can be static and/or dynamic in nature. For example, the distribution logic 110 can configure a given customized content package 112 to be static in nature when two or more syndication recipients 114 indicate that no customizations are necessary. In another example, a given customized content package 112 can be dynamic in nature such that the customized content package 112 changes in accordance with the circumstances under which a rendering of the customized content package 112 is being performed at client computing devices 120. For example, two or more syndication recipients 114 may indicate that the only customization necessary is “Buy it now at <company name>”. In this example, the distribution logic 110 can configure the customized content package 112 with the necessary logic (e.g., scripts, code, etc.) to effectively identify the company name based on a uniform resource locator (URL) that is visited by the client computing device 120 and to inject it into the “<company name>” placeholder. In another example, two or more syndication recipients 114 may indicate that the only customizations necessary are color changes that correspond to their respective geographical locations. In this example, the distribution logic 110 can configure the customized content package 112 with the necessary logic to effectively identify the locales (e.g., of the syndication recipients 114, the client computing devices 120, etc.) using available tools (e.g., locations indicated by web browsers on the client computing devices 120) and to perform the color changes in accordance with the locales. It is noted that the foregoing examples are not meant to be limiting, and that the customized content package 112 can be configured to be dynamic in nature, at any level of granularity and based on any circumstances, without departing from the scope of this disclosure.

In any case, when the customized content package 112 is generated, the syndication provider 106 is then capable of distributing the customized content package 112 to different client computing devices 120 that request the customized content package 112. The provision of such information can arise under a variety of scenarios. In one scenario, a given client computing device 120 can request to access syndication recipient content 118, which can represent, for example, a website page of an online store that is associated with the syndication recipient 114. In turn, the client computing device 120 can generate a rendering of the syndication recipient content 118 (e.g., display the website page of the online store in a web browser on the client computing device 120). In this example, an area of the website page can reference a particular one of the customized content packages 112 that was generated by the syndication provider 106 in response to the syndication recipient 114 providing a content customization package 116 at an earlier time. This reference can be implemented, for example, using an iFrame tag when hypertext markup language (HTML) approaches are utilized by the online store. In any case, the reference can be linked to the syndication provider 106—and, when the client computing device 120 invokes the reference, the syndication provider 106 can lookup and provide the customized content package 112. In turn, the customized content package 112 can be provided to and processed by the client computing device 120. This can involve, for example, the client computing device 120 generating a visual rendering of the customized content package 112 (amidst the visual rendering of the syndication recipient content 118).

It is noted that the foregoing scenario is exemplary and not meant to be limiting. In particular, various approaches can be utilized to effectively enable customized content packages 112 to be delivered to client computing devices 120 where appropriate. For example, the syndication recipient content 118 of a given syndication recipient 114 can simply point to a customized content package 112 such that customized content package 112 constitutes all of the syndication recipient content 118 (as opposed to content that is embedded within the syndication recipient content 118). This can be beneficial in scenarios where the syndication recipient 114 determines that the customized content package 112 encompasses the entirety of the information that the syndication recipient 114 is interested in providing to its users.

Accordingly, FIG. 1 sets forth an overview of the various members that participate in the system 100 in order to implement the various techniques discussed herein. It is noted that different entities in FIG. 1 can be combined to perform the same techniques without departing from the scope of this disclosure. For example, a given content provider 102 can be configured to implement the functionalities provided by one or more of the syndication providers 106. Additionally, it is noted that different entities not illustrated in FIG. 1 can be incorporated into the system 100 to assist/supplement the entities described herein and illustrated in FIG. 1. For example, the content providers 102, the syndication providers 106, and the syndication recipients 114 can interface with other entities to provide a subset of the functionalities provided by the content providers 102, the syndication providers 106, and the syndication recipients 114, respectively, without departing from the scope of this disclosure.

FIGS. 2A-2E set forth conceptual diagrams 200 of an example flow of how a customizable content package 104 can be distributed to a syndication provider 106 and customized by a syndication recipient 114, according to some embodiments. As shown in FIG. 2A, a step 202 involves a syndication recipient 114 receiving a customizable content package 104 from a syndication provider 106. In the example illustrated in FIG. 2A, the customizable content package 104 includes various objects for generating content that is compatible with web browsers, such as HTML, information 152, cascading style sheet (CSS) information 154, script information 156, asset information 158, and/or the like. Again, however, it is noted that the customizable content package 104 can include information for generating additional types of content (including non-web browser content), such as image data, illustration data, sound data, video data, simulation data, and so on.

In any case, as shown in FIG. 2A, the syndication recipient 114 can utilize the customizable content package 104 to generate a customizable content package rendering 203. As shown in FIG. 2A, customizable content package rendering 203 relates to product information for a display device and includes different areas capable of customization by the syndication recipient 114. In the example, shown in FIG. 2A, the different areas include a customizable text area (denoted “customizable text 1”), and three customizable panels (denoted “customizable panel <1,2,3>”). As described above in conjunction with FIG. 1, the content provider 102 can establish the customizable areas to effectively indicate to the syndication recipient 114 the areas that are customizable and the areas that are not. It is noted that any effective approach for delineating the customizable areas can be utilized without departing from the scope of this disclosure. For example, the content provider 102 can encompass the customizable areas in dotted lines (as illustrated in FIG. 2A). In another example, the content provider 102 can include a navigation panel that enables a step-through of the different customizable areas. In yet another example, the content provider 102 can include highlights around the customizable areas to draw attention to them. It is noted that the foregoing examples are not meant to be limiting, and that any approach can be used to effectively call out the customizable areas of the customizable content package 104 without departing from the scope of this disclosure. It also noted that any approach can be used to restrict or permit customizations to the customizable content package 104 without departing from the scope of this disclosure.

Turning now to FIG. 2B, a step 204 involves the syndication recipient 114 identifying different content customizations 222 made to the customizable content package 104, which are shown in the customized content package rendering 224. As shown in FIG. 2B, the customizations include replacing the “customizable text 1” area with text that reads “In stores nationwide on 12/16!”. The customizations also include replacing the three customizable panels with hyperlinks to additional content that the syndication recipient 114 would like to enable its customers to digest (if so desired) when browsing the web page. It is again noted that the customizations illustrated in FIG. 2B are exemplary and not meant to be limiting, and that any form of customizations at any level of granularity (that nonetheless conform to rules imposed by the customizable content package 104, if enforced) can be accommodated without departing from the scope of this disclosure. Additionally, it is noted that different approaches can be used to account for customizable areas that do not receive customization. For example, an ignored customizable area can simply default back to other content that is included in the customizable content package 104. In another example, an ignored customizable area can be configured to disappear from the rendering so that no visual gaps are left in the customizable content package 104. It is noted that these examples are not meant to be limiting and that unaddressed customizable areas can be configured to exhibit any form of behavior, at any level of granularity, without departing from the scope of this disclosure.

In any case, the syndication recipient 114 generates a content customization package 116 based on the different content customizations 222 made to the customizable content package 104. As shown in FIG. 2B, the content customization package 116 can include any information needed to effectively reflect the different customizations 222 to the customizable content package 104. For example, the content customization package 116 can include HTML information 162, cascading style sheet (CSS) information 164, script information 166, asset information 168, and/or the like. Additionally (or alternatively), the content customization package 116 can include information—e.g., an instruction set—that effectively enables the syndication provider 106 to identify how the customizable content package 104 should be customized. For example, the instructions could be provided in plain text (e.g., “Change ‘customizable text 1’ to ‘In stores nationwide on 12/16!’, change “customizable panel 1” to a hyperlink titled ‘See what the experts have to say’ and directed to ‘Domain.com/ExpertReviews/FlagshipDisplayDevice’, and so on). In this example, the distribution logic 110 can implement the necessary tools to effectively parse the plain text and generate a content customization package 116 based on the instructions included therein (e.g., using machine learning techniques). In any case, the syndication recipient 114 provides the content customization package 116 to the syndication provider 106 at the conclusion of step 204.

Turning now to FIG. 2C, a step 206 involves the syndication recipient 114 (upon receiving the content customization package 116) generating a customized content package 112. In particular, the syndication recipient 114 can utilize the distribution logic 110 to generate the customized content package 112 based on the customizable content package 104 and the syndication provider 106, e.g., using the generation techniques described above in conjunction with FIG. 1. As shown in FIG. 2C, the customized content package 112 can include HTML information 172, cascading style sheet (CSS) information 174, script information 176, asset information 178, and/or the like. Again, it is noted that such information can include all information necessary to represent the customizations, delta information that can be used to represent the customizations through comparison to the customizable content package 104, and so on (as also described above in conjunction with FIG. 1).

Turning now to FIG. 2D, a step 208 involves a client computing device 120 issuing a request for content 230 to the syndication recipient 114. In the example illustrated in FIG. 2D, this step involves the client computing device 120 attempting to visit an online stored hosted by the syndication recipient 114, which can be managed through the syndication recipient content 118 (i.e., a package of information for the online store). In turn, the syndication recipient content 118 (or some portion thereof) is provided to the client computing device 120 in response to the request. Thereafter, the client computing device 120 can generate a syndication recipient content rendering 232 of the syndication recipient content 118—which, as shown in FIG. 2D, includes (1) content that is specific to and provided by the online store (i.e., “What's New”, “As always, we offer . . . ”, etc.), and (2) a placeholder (illustrated in FIG. 2 as the syndication provider content placeholder 234) that references content (i.e., the customized content package 112 established in conjunction with step 208 of FIG. 2D) that is provided by the syndication provider 106. Again, the reference can be implemented using any of the techniques discussed herein, such as an iFrame that is included in the syndication recipient content 118 that refers to the customized content package 112.

Turning now to FIG. 2E, a step 210 involves the client computing device 120—in conjunction with identifying the reference to the customized content package 112 included in the syndication recipient content 118—issues, to the syndication provider 106, a request for the customized content package 112 (illustrated in FIG. 2E as the request for customized content package 240). In turn, the syndication provider 106 identifies the customized content package 112 (generated in conjunction with FIGS. 2A-2C) based on the request and provides the customized content package 112 to the client computing device 120. Subsequently, the client computing device 120 generates a syndication recipient content rendering 242 that incorporates both the syndication recipient content 118 as well as the customized content package 112 (illustrated in FIG. 2E as the customized content package rendering 244).

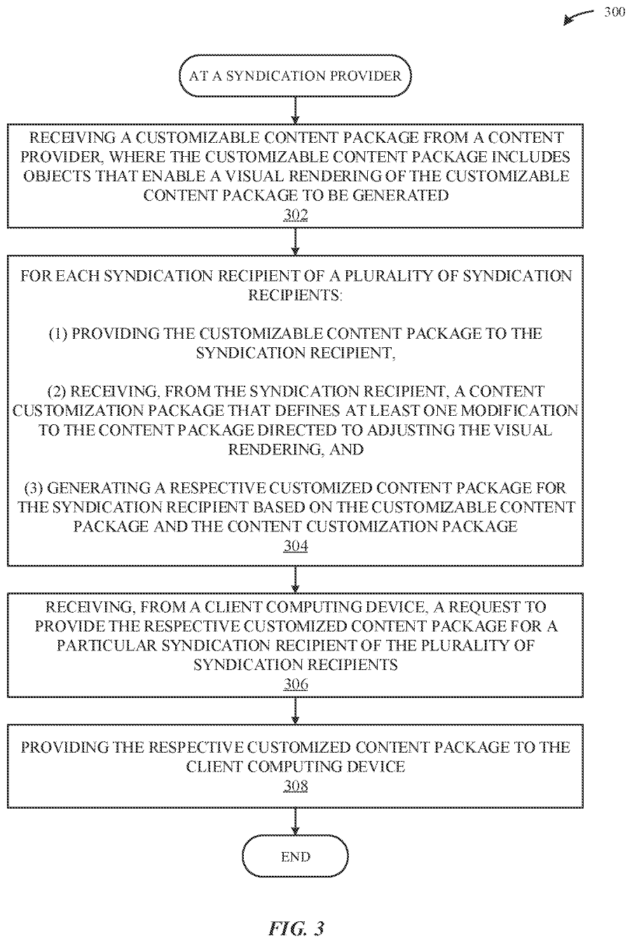

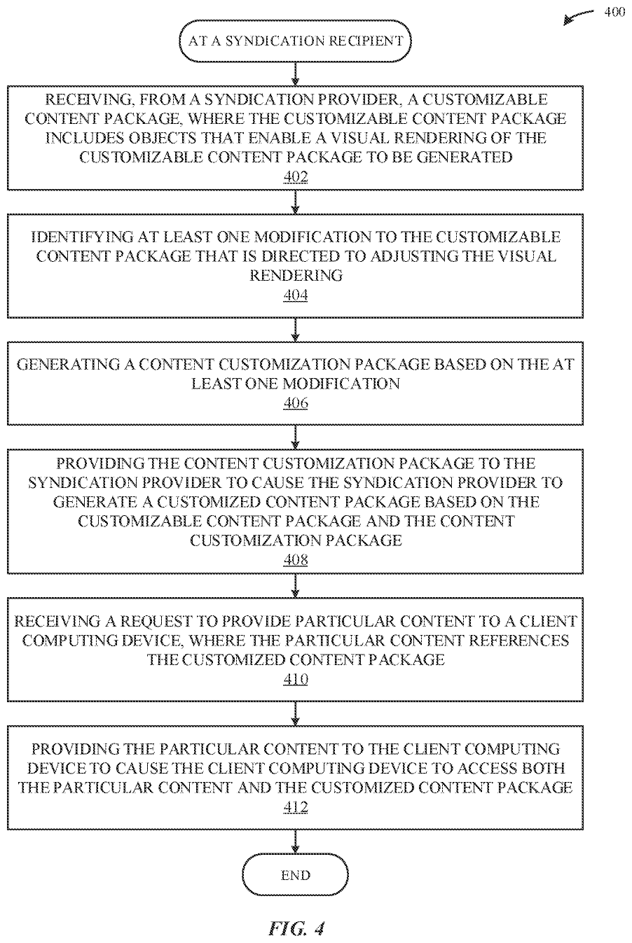

Accordingly, FIGS. 2A-2E set forth conceptual diagrams of an example flow of how a customizable content package 104 can be distributed to a syndication provider 106 and customized by a syndication recipient 114, according to some embodiments. Additionally, FIG. 3 provides a high-level method that can be implemented by the syndication provider 106 to provide the techniques discussed herein, according to some embodiments. Additionally, FIG. 4 provides a high-level method can be implemented by the syndication recipient 114 to provide the techniques discussed herein, according to some embodiments.

FIG. 3 illustrates a method 300 for syndicating customizable content, according to some embodiments. According to some embodiments, the method 300 can be implemented by the syndication provider 106 of FIG. 1. As shown in FIG. 3, the method 300 begins at step 302, where the syndication provider 106 receives a customizable content package 104 from a content provider 102, and where the customizable content package 104 includes objects that enable a visual rendering of the customizable content package 104 to be generated (e.g., as described above in conjunction with FIGS. 1 and 2A-2E).

At step 304, the syndication provider 106 performs the following steps for each syndication recipient 114 of a plurality of syndication recipients 114 (e.g., identified based on the customizable content package 104). A first step involves the syndication provider 106 providing the customizable content package 104 to the syndication recipient 114 (e.g., as described above in conjunction with FIGS. 1 and 2A-2E). A second step involves the syndication provider 106 receiving, from the syndication recipient 114, a content customization package 116 that defines at least one modification to the customizable content package 104 directed to adjusting the visual rendering (e.g., as described above in conjunction with FIGS. 1 and 2A-2E). A third step involves the syndication provider 106 generating a respective customized content package 112 for the syndication recipient 114 based on the customized content package 112 and the customizable content package 104 (e.g., as described above in conjunction with FIGS. 1 and 2A-2E).

At step 306, the syndication provider 106 receives, from a client computing device 120, a request to provide the respective customized content package 112 for a particular syndication recipient 114 of the plurality of syndication recipient 114 (e.g., as described above in conjunction with FIGS. 1 and 2A-2E). At step 308, the syndication provider 106 provides the respective customized content package 112 to the computing device 120 (e.g., as described above in conjunction with FIGS. 1 and 2A-2E).

FIG. 4 illustrates a method 400 for managing syndicated customizable content, according to some embodiments. As shown in FIG. 4, the method 400 begins at step 402, where the syndication recipient 114 receives, from a syndication provider 106, a customizable content package 104, where the customizable content package 104 includes objects that enable a visual rendering of the customizable content package 104 to be generated (e.g., as described above in conjunction with FIGS. 1, 2A-2E, and 3).

At step 404, the syndication recipient 114 identifies at least one modification to the customizable content package 104 that is directed to adjusting the visual rendering (e.g., as described above in conjunction with FIGS. 1, 2A-2E, and 3). At step 406, the syndication recipient 114 generates a content customization package 116 based on the at least one modification (e.g., as described above in conjunction with FIGS. 1, 2A-2E, and 3). At step 408, the syndication recipient 114 provides the content customization package 116 to the syndication provider 106 to cause the syndication provider 106 to generate a customized content package 112 based on the customizable content package 104 and the content customization package 116 (e.g., as described above in conjunction with FIGS. 1, 2A-2E, and 3).

At step 410, the syndication recipient 114 receives a request to provide particular content (e.g., the syndication recipient content 118) to a client computing device 120, where the particular content (i.e., the syndication recipient content 118) references the customized content package 112 (e.g., as described above in conjunction with FIGS. 1, 2A-2E, and 3). At step 412, the syndication recipient 114 provides the particular content (i.e., the syndication recipient content 118) to the client computing device 120 to cause the client computing device 120 to access both the particular content (i.e., the syndication recipient content 118) and the customized content package 112.

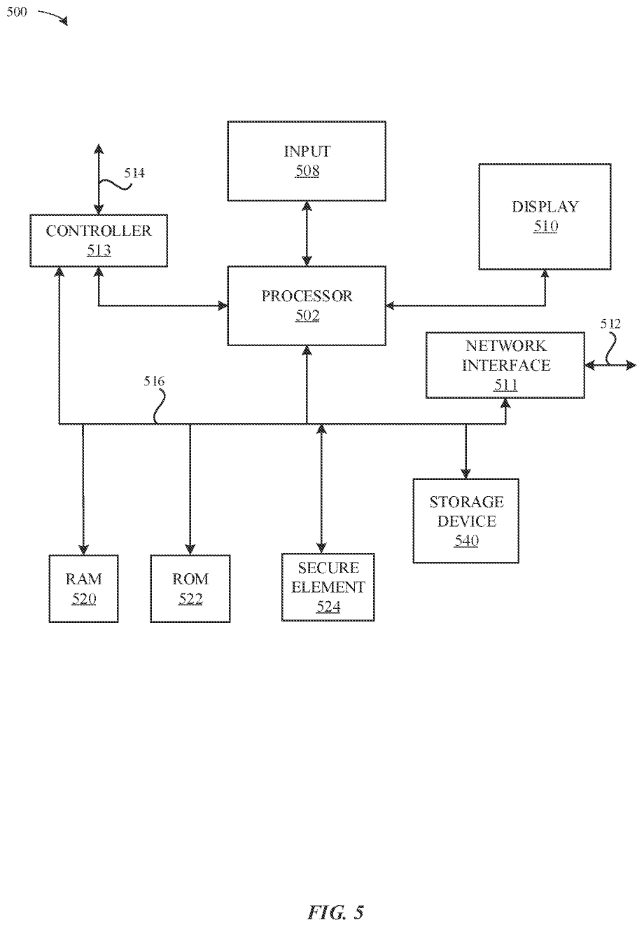

FIG. 5 illustrates a detailed view of a representative computing device 500 that can be used to implement various methods described herein, according to some embodiments. In particular, the detailed view illustrates various components that can be included in one or more computing devices associated with the content providers 102, one or more computing devices associated with the syndication providers 106, one or more computing devices associated with the syndication recipients 114, and the client computing devices 120. As shown in FIG. 5, the computing device 500 can include a processor 502 that represents a microprocessor or controller for controlling the overall operation of computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, etc. Still further, the computing device 500 can include a display 510 that can be controlled by the processor 502 to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that communicatively couples to a data link 512. In the case of a wireless connection, the network/bus interface 511 can include a wireless transceiver.

The computing device 500 also includes a storage device 540, which can comprise a single disk or a plurality of disks (e.g., hard drives), and includes a storage management module that manages one or more partitions within the storage device 540. In some embodiments, storage device 540 can include flash memory, semiconductor (solid state) memory or the like. The computing device 500 can also include a Random Access Memory (RAM) 520 and a Read-Only Memory (ROM) 522. The ROM 522 can store programs, utilities, or processes to be executed in a non-volatile manner. The RAM 520 can provide volatile data storage, and stores instructions related to the operation of the computing device 500. The computing device 500 can further include a secure element (SE) 524 for cellular wireless system access by the computing device 500.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

Regarding the present disclosure, it is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for syndicating customizable content, the method comprising, at a server computing device associated with a syndication provider:
receiving a customizable content package from a content provider, wherein the customizable content package includes objects that enable a visual rendering of the customizable content package to be generated;
for each syndication recipient of a plurality of syndication recipients:
providing the customizable content package to the syndication recipient,
receiving, from the syndication recipient, a content customization package that defines at least one modification to the customizable content package directed to adjusting the visual rendering, and
generating a respective customized content package for the syndication recipient based on the customizable content package and the content customization package;
receiving, from a client computing device, a request to provide the respective customized content package for a particular syndication recipient of the plurality of syndication recipients; and
providing the respective customized content package to the client computing device.

2. The method of claim 1, wherein:
the request is issued by the client computing device in conjunction with the client computing device requesting particular content from the server computing device, and
the particular content includes at least one reference to the respective customized content package.

3. The method of claim 2, wherein the respective customized content package includes second objects that enable a second visual rendering of the respective customized content package to be generated.

4. The method of claim 3, wherein the second visual rendering is embedded in a third visual rendering of the particular content provided by the server computing device to the client computing device.

5. The method of claim 4, wherein the second visual rendering is embedded using a hypertext markup language (HTML) iFrame tag.

6. The method of claim 4, wherein the respective customized content package includes:
hypertext markup language (HTML),
one or more cascading style sheets (CSS),
one or more scripts, and/or
one or more assets.

7. The method of claim 6, wherein at least one of the one or more scripts:
generates a unique identifier based on a uniform resource locator (URL) that corresponds to the particular content associated with the server computing device,
associates the unique identifier with the request, and
issues the request to the server computing device.

8. The method of claim 1, wherein the plurality of syndication recipients are identified based on the customizable content package.

9. A method for managing syndicated customizable content, the method comprising, at a server computing device associated with a syndication recipient:
receiving, from a syndication provider, a customizable content package, wherein the customizable content package includes objects that enable a visual rendering of the customizable content package to be generated;
identifying at least one modification to the customizable content package that is directed to adjusting the visual rendering;
generating a content customization package based on the at least one modification;
providing the content customization package to the syndication provider to cause the syndication provider to generate a customized content package based on the customizable content package and the content customization package;
receiving a request to provide particular content to a client computing device, wherein the particular content references the customized content package; and
providing the particular content to the client computing device to cause the client computing device to access both the particular content and the customized content package.

10. The method of claim 9, wherein the customizable content package is initially provided by a content provider to the syndication provider.

11. The method of claim 9, wherein a second visual rendering of the customized content package is embedded in a first visual rendering of the particular content.

12. The method of claim 11, wherein the embedding is performed using a hypertext markup language (HTML) iFrame tag included in the particular content.

13. The method of claim 9, wherein the customized content package includes:
hypertext markup language (HTML),
one or more cascading style sheets (CSS),
one or more scripts, and/or
one or more assets.

14. A non-transitory computer readable storage medium configured to store instructions that, when executed by a processor included in a server computing device associated with a syndication provider, cause the server computing device to syndicate customizable content, by carrying out steps that include:
receiving a customizable content package from a content provider, wherein the customizable content package includes objects that enable a visual rendering of the customizable content package to be generated;
for each syndication recipient of a plurality of syndication recipients:
providing the customizable content package to the syndication recipient,
receiving, from the syndication recipient, a content customization package that defines at least one modification to the customizable content package directed to adjusting the visual rendering, and
generating a respective customized content package for the syndication recipient based on the customizable content package and the content customization package;
receiving, from a client computing device, a request to provide the respective customized content package for a particular syndication recipient of the plurality of syndication recipients; and
providing the respective customized content package to the client computing device.

15. The non-transitory computer readable storage medium of claim 14, wherein:
the request is issued by the client computing device in conjunction with the client computing device requesting particular content from the server computing device, and
the particular content includes at least one reference to the respective customized content package.

16. The non-transitory computer readable storage medium of claim 15, wherein the respective customized content package includes second objects that enable a second visual rendering of the respective customized content package to be generated.

17. The non-transitory computer readable storage medium of claim 16, wherein the second visual rendering is embedded in a third visual rendering of the particular content provided by the server computing device to the client computing device.

18. The non-transitory computer readable storage medium of claim 17, wherein the second visual rendering is embedded using a hypertext markup language (HTML) iFrame tag.

19. The non-transitory computer readable storage medium of claim 17, wherein the respective customized content package includes:
hypertext markup language (HTML),
one or more cascading style sheets (CSS),
one or more scripts, and/or
one or more assets.

20. The non-transitory computer readable storage medium of claim 19, wherein at least one of the one or more scripts:
generates a unique identifier based on a uniform resource locator (URL) that corresponds to the particular content associated with the server computing device,
associates the unique identifier with the request, and
issues the request to the server computing device.
